(19) United States
(12) Patent Application Publication
(10) Pub. No.: US 2010/0204806 A1
(43) Pub. Date: Aug. 12, 2010

(54) Automation System Having A Programmable Matrix Module

(75) Inventors: Michael Chowaniec, Chemnitz (DE); Gunter Griessbach, Gelenau (DE); Klaus Rohne, Lichtenstein (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/699,696

(22) Filed: Feb. 3, 2010

(30) Foreign Application Priority Data
Feb. 3, 2009 (DE) 10 2009 007 215.2

(51) Int. Cl. G05B 19/042

(52) U.S. Cl. 700/19

(57) ABSTRACT

An automation system for controlling a technical process having an electronic processing unit, input/output (I/O) modules for inputting and outputting process signals to operating means of the technical process, such as sensors and actuators, and terminal modules for connecting the operating means to the I/O modules. The automation system also includes a programmable matrix module that can be used by the electronic processing unit to dynamically associate, i.e., connect, one or more I/O modules with one or more terminal modules.

### BACKGROUND OF THE INVENTION

Generally, automation devices have a multiplicity of input and/or output modules or I/O modules. An electronic processing unit in the automation device, such as a program-controlled processor, can preferably use the I/O modules to receive measurement signals from a technical process or system and to output actuating signals or control commands to operating means of the technical process. A multiplicity of terminals, which can be combined in terminal areas, for example, are provided to connect the I/O modules to these technical operating means, such as sensors and actuators, usually by process cabling and field buses.

In addition, conventional automation devices are typically constructed such that there is direct coupling, i.e., a type of linear connection, from the electronic processing unit, through the I/O modules, directly to a terminal area. Here, each I/O module is rigidly associated with a defined terminal, i.e., hard-wired to the defined terminal and is thus functionally linearly connected thereto. The order, association and position between each individual terminal and each individual I/O module are therefore defined and rigidly set in an automation device. As a result, a change or a free selective association between an I/O module and a terminal or an expansion in an installed system is not possible without performing complicated disconnection, reconnection or conversion. If there is limited space, such relocations may also be impossible in the case of individual components.

DE 10 2004 010 003 A1 discloses a conventional automation system having connections for field devices, a supply component and a measuring component for the field devices, as well as a connecting unit for optionally connecting the field device connections to the connections of the supply and measuring components. This automation system readily resolves the disadvantage of the rigid association between the terminals and the field devices or the I/O modules. Here, the programmable matrix module can be used to connect the processing unit to the terminal modules through the I/O modules by software programming. However, this conventional automation system fails to make optimal use of the existing I/O modules.

### SUMMARY OF THE INVENTION

It is therefore an object of the invention to develop an automation system for controlling a technical process such that optimal use can be made of the existing I/O modules.

This and other objects and advantages are achieved by an automation system including an electronic processing unit, I/O modules for inputting and/or outputting process signals to operating means of the technical process, such as sensors and actuators, and terminal modules for connecting the operating means of the system to the I/O modules. The automation system also includes a programmable matrix module which can be used by the processing unit to dynamically associate, i.e., connect, one or more I/O modules with one or more terminal modules. In accordance with the invention, the processing unit is advantageously configured such that a plurality of terminal modules can be associated, i.e., connected, with an I/O module in a time-controlled manner with the aid of the programmable matrix module, one time slot being associated with each terminal module. As a result, a “free” program-controlled association is provided between the I/O modules and the terminal modules.

In an embodiment, the processing unit ascertains, for example, in a hardware pool which may comprise a number of I/O modules, which hardware is currently idling and then entrusts (or assigns) the idle hardware with new tasks, where the required I/O module is connected to the terminal modules. It is thus advantageously possible, for example, for a single I/O module to interrogate the process signals from a plurality of operating means at the respective terminal modules in a staggered manner, for example in a temporal order, and to gradually output them to the operating means.

In one advantageous embodiment, the automation system includes a multiplexer that is provided in the programmable matrix module. Here, the multiplexer preferably comprises a selection-switching network, where virtually parallel data streams are converted into serial data streams in different time slots during cyclical operation of the multiplexer. The different terminal modules are therefore scanned in a staggered manner in temporal succession, and their input and output values are forwarded to the processing unit through/by the single I/O module. The presently contemplated embodiment of the automation system can be advantageously used to manage an automation task for which a plurality of I/O modules were previously required, where the same automation task can be managed using a single I/O module. As a result, the cost and size of the automation device are advantageously reduced, because it is possible to dispense with complete subassemblies or additional I/O modules.

In another advantageous embodiment, the automation system increases the flexibility of the results that can be achieved by configuring the processing unit to activate the I/O module over a coupling bus.

Based on the particular application, it is thus possible to dynamically rank, by programming, the process signals received from the operating means of a technical process or the process signals determined by the processing unit and output to the operating means. In accordance with the contemplated embodiments, the programmable matrix module operates as a freely programmable switching, where each I/O module is connected to each terminal module. Here, the connection association can be set up in a technical system, for example, when configuring the automation system, or can be flexibly updated during ongoing operation of the system. The technical operating means of a system, special sensors and actuators distributed in the field, can therefore be connected to easily accessible terminal modules during start-up, for example, taking into account a minimum amount of cable and ranking complexity. In alternative embodiments, the I/O modules are arranged without restriction, for example, taking into account the topology of the respective system. As a result, the risk of fitting and wiring faults, for example, creating mistakes when associating the I/O modules and the terminal module, can therefore be minimized.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Advantageous further embodiments of the invention are specified in the subclaims. The invention is explained in more detail below using the figures which are briefly cited below and in which:

FIG. 1 shows a schematic block diagram of an automation system equipped with an additional programmable matrix module for ranking process signals in accordance with an exemplary embodiment of the invention; and

FIG. 2 shows an exemplary structure of an interface module in an automation device, which has a terminal area, a multiplicity of I/O modules and a programmable matrix module for process signals in accordance with an embodiment of the invention.

### DETAILED DESCRIPTION OF THE PRESENTLY PREFERRED EMBODIMENTS

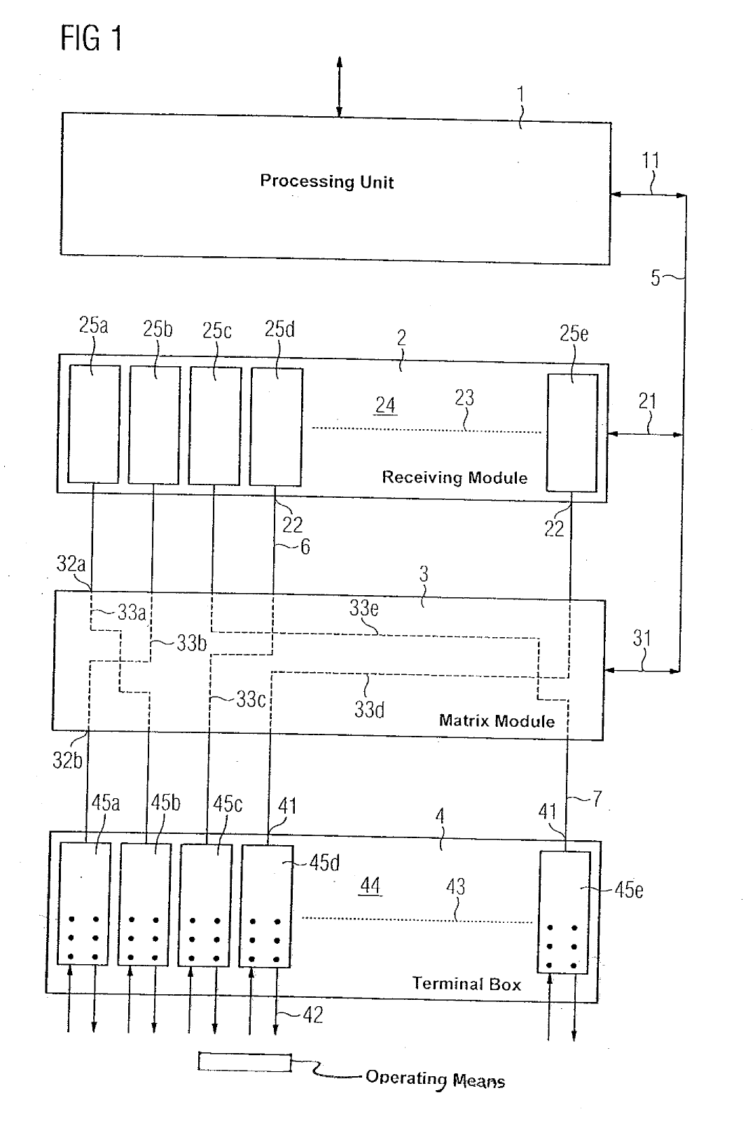

FIG. 1 is an exemplary schematic block diagram of an automation system equipped in accordance with the invention. The automation system contains an electronic processing unit 1, such as a programmable logic controller (PLC), which processes signals from a technical process in a known manner using application-specific programs. The electronic processing unit 1 uses the signals to derive actuating signals and commands for influencing the technical process. These input and output signals are interchanged with the operating means of the technical system, i.e., with transducers, sensors, actuators using a process interface 42 which is illustrated at the lower section of the exemplary embodiment shown in FIG. 1, such as by field buses or simple multi-wire connections. In alternative embodiments, data buses, operation and observation devices, and many other types of devices, are also connected to the electronic processing unit 1 by communication interfaces. The additional devices are not illustrated in the block diagram of FIG. 1 for reasons of clarity.

In the exemplary embodiment shown in FIG. 1, a receiving module 2 with receiving slots for I/O modules arranged, for example, in rack form, a programmable matrix module 3 in accordance with the invention and an exemplary terminal box 4 with terminal slots for connection terminals are arranged between the electronic processing unit 1 and the process interface 42. The electronic processing unit 1, the receiving module 2, the programmable matrix module 3 and the terminal box 4 are coupled for data processing to a first data bus interface 11 of the electronic processing unit 1 by a coupling bus having the outgoing sections 5-7. The coupling bus is thus looped through the receiving module 2 by a first data interface 21, a backplane bus 23 and a second data interface 22. The receiving module 2 provides receiving slots for I/O modules, the receiving slots 24 of which are unoccupied in the exemplary embodiment shown in FIG. 1 and the remaining receiving slots of which are occupied by I/O modules 25a-25e. In preferred embodiments, the I/O modules are intelligent interface modules. Here, the intelligent interface modules have processing means with a computational which makes it possible to pre-process or post-process input and output signals from the technical process and thus to relieve the load on the electronic processing unit 1. Input and output subassemblies for binary or analog process signals are examples of these types of modules.

In accordance with the contemplated embodiments, the signals at the output of each I/O module are either intended for one or more operating means of the technical process or are provided by one or more operating means. It is thus necessary for the outputs of the I/O modules in the receiving module 2 to be associated with the cable connections of the technical process that lead to the respective operating means. In the exemplary embodiment depicted in FIG. 1, these cable connections are brought into contact with the process interface 42 at terminal modules that are combined in the terminal box 4. Here, the coupling bus is also looped into the terminal box 4, for data processing, at the outgoing section 7 through a data bus interface 41 and is looped through by a backplane bus 43. Here, the terminal box 4 provides terminal slots for terminal modules, where the terminal slots 44 are unoccupied in the exemplary embodiment shown in FIG. 1, and the remaining terminal slots are occupied by terminal modules 45a-45e. In accordance with the contemplated embodiments, the terminal modules may be equipped with a different cable connection technology, such as screw-type contacts or spring clamp contacts.

With additional reference to FIG. 1, the programmable matrix module 3 is arranged between the receiving module 2 and the terminal box 4. This programmable matrix module 3 is connected to the outgoing sections 6, 7 of the coupling bus, such as by data interfaces 32a, 32b. Moreover, the programmable matrix module 3 is connected to the coupling bus 5 by a data interface 31. This data interface can be used by the electronic processing unit 1 to parameterize the programmable matrix module 3 by programming such that one or more I/O modules 25a-25e are dynamically associated, i.e., connected, with one or more terminal modules 45a-45e. Such exemplary programming links are illustrated in FIG. 1, where program path 33a links the module 25a to the terminal 45b, program path 33b links the module 25b to the terminal 45a, program path 33c links the module 25d to the terminal 45c, program path 33d links the module 25e to the terminal 45d and program path 33e links the module 25c to the terminal 45e. It should be understood that the programming links shown in FIG. 1 are only exemplary and, under certain circumstances, can also be dynamically adapted by the electronic processing unit 1 during ongoing operation. If, for example, the electronic processing unit 1 is informed of the failure of an I/O module by programming, the electronic processing unit 1 can dynamically associate, i.e., connect, another I/O module with the associated terminal module, which can no longer receive any process signals or transmit any process signals to the electronic processing unit 1, due to the failure, with the aid of the programmable matrix module. As a result, the automation system is enabled to continue operating. As part of redundant system instrumentation, for example, more I/O modules than are required for normal operation can thus be plugged into the receiving module 2. In this case, the processing unit would dynamically associate, i.e., connect, the affected terminal module with an I/O module that has hitherto not been used.

Depending on the specific configuration of the automation system in accordance with the disclosed embodiments, it may be possible for the electronic processing unit to also detect the failure of an operating means of the technical process, such as a sensor or an actuator. Here, the contemplated embodiments of the invention makes it possible for the electronic processing unit 1 to dynamically associate, i.e., connect, another terminal module with the affected I/O module, which can no longer transfer any process signals to the technical process or can no longer receive any signals from the affected I/O module due to the failure, with the aid of the programmable matrix module 3. If the other terminal module is connected to operating means of the system that are at least to a limited extent functional, it is possible, under certain circumstances, to maintain the operation of the operating means using equivalent process signals or at least to effect an organized shutdown. If the technical process is provided with standby operating means as part of a redundancy concept, for example, with replacement pumps or emergency drives, the processing unit will then advantageously dynamically associate, i.e., connect, a terminal module, to which a redundant operating means of the technical system is connected, with the affected I/O module.

In other embodiments, it is possible, under certain circumstances, for the electronic processing unit 1 to dynamically associate, i.e., connect, a plurality of terminal modules with one I/O module with the aid of the programmable matrix module 3. Here, the I/O module advantageously activates these terminal modules in a cyclical manner, in particular for the purpose of inputting and outputting process signals. In practice, such a situation may occur particularly when operating means of the technical process, the states of which vary slowly in comparison with the processing speed of the I/O module, are connected to terminal modules. Operating means of this type may be, for example, heaters and the temperature sensors connected to the heaters. Consequently, it is possible for a single I/O module to interrogate the process signals from a plurality of operating means at the respective terminal modules in a staggered manner, such as in a temporal order, and to gradually output the process signals to the operating means. The programmable matrix module then additionally has the function of a multiplexer.

In alternative embodiments, it is possible for the electronic processing unit 1 to dynamically associate, i.e., connect, a single terminal module with a plurality of I/O modules with the aid of the programmable matrix module 3. Here, the I/O modules also activate this single terminal module in a cyclical manner, in particular for the purpose of inputting and outputting process signals. Such a situation may occur in practice particularly when an operating means of the technical process, the state of which varies rapidly in comparison with the processing speed of the I/O modules used, is connected to a terminal module. An operating means of this type may be, for example, a variable-speed drive and a speed sensor connected to the variable-speed drive. As a result, it is possible for a plurality of I/O modules to interrogate the rapidly varying process signal from the single operating means of the respective terminal module, such as in a temporal order using a time slot method, and to output the process signal to the operating means. Here, as before, the programmable matrix module then additionally has the function of a multiplexer.

In a further advantageous embodiment, the electronic processing unit 1 dynamically detects, i.e., during start-up, the existing I/O modules in a first search and the operating means of the technical process that are connected to the terminal modules in a second search. Here, the I/O modules and operating means are preferably detected by type and slot. Basically, the activatable rows and columns in the programmable matrix module are thus determined. The electronic processing unit 1 can now automatically dynamically associate, i.e., connect, one or more terminal modules with one or more I/O modules, in particular based on an application-dependent control program. In preferred embodiments, the electronic processing unit 1 performs the search during initial start-up. Alternatively, the electronic processing unit 1 also performs the search at a subsequent point in time or repeatedly. The automation system thus uses the first search to initially detect the type and arrangement of the installed I/O modules, i.e., the occupation of the receiving slots in the receiving module 2 shown in FIG. 1 by a particular I/O module. In a further search, the operating means of the technical process, in particular the sensors and actuators, which are connected to the respective terminal modules in the terminal box 4 are then detected.

The disclosed embodiments of the invention facilitate the use of dynamic programming because it is possible to achieve quasi-neural networking of I/O modules to the terminal modules. Consequently, more object-oriented execution of control programs is enabled, with the result that important performance features of an automation system, such as redundancy, processing speed or accuracy, can be more optimally scaled. The free association between the I/O modules and the process terminals with the aid of the program-controlled matrix module 3 also makes it advantageously possible to implement new functions in a programmable logic controller. The electronic processing unit 1 can thus inquire, for example, within the hardware pool, which I/O modules are temporarily idling. The idling modules can then be entrusted with new or alternative control or measuring tasks and can be connected to the required terminals using the programmable matrix module. These dynamic associations can also be made in a stochastically anticipatory manner or a self-optimizing manner.

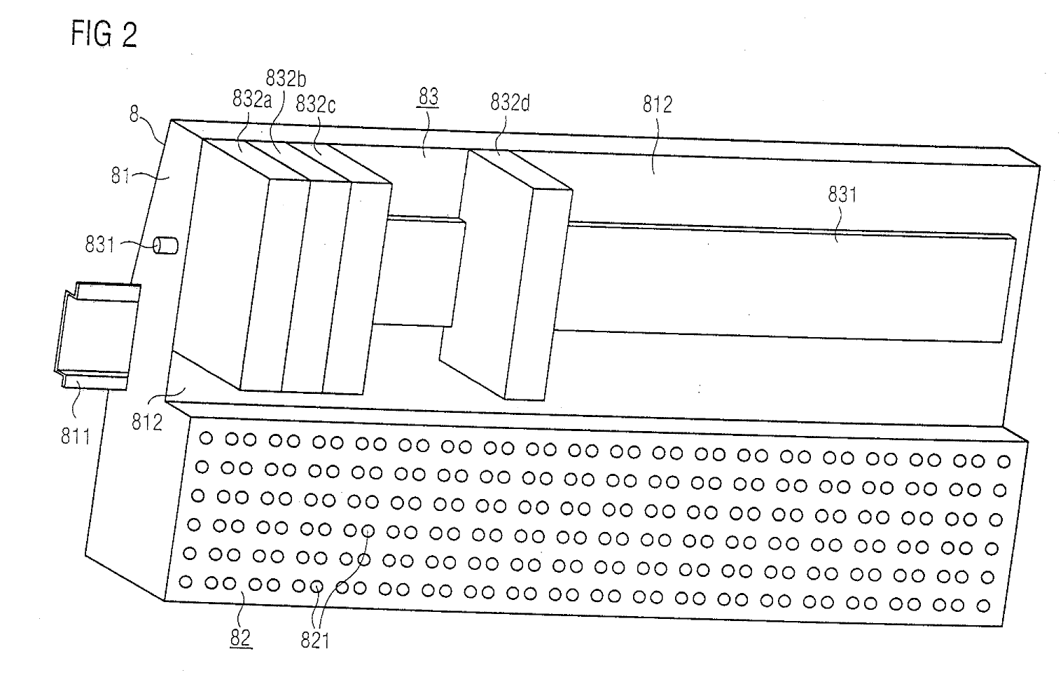

FIG. 2 shows an exemplary structure of a separate interface module 8 for an automation system. The housing 81 of the interface module is provided, on the rear side 811, with engagement means for holding a top-hat rail. The front side of the housing 81 includes a connection area 812 having an interface plane 83 in an upper area and a wiring plane 82 in a lower area. The wiring plane 82 includes, for example, a multiplicity of wiring terminals 821. Process signal lines routed from a technical system may be brought into contact with these wiring terminals 821. In the exemplary structure shown in FIG. 2, two adjacent rows of 6 connections, which are arranged vertically above one another, are respectively grouped to form one terminal module. Moreover, in the exemplary structure of FIG. 2, the three slots at the left-hand end of the interface plane 83 are also each fitted with an I/O module 832a, 832b, 832c, whereas the three further slots which follow to the right are unoccupied. A further I/O module 832d is also connected. The I/O modules are coupled to one another for data processing by the backplane bus 831. It should be noted that the backplane bus 831 also forms the connection to a processing unit (not illustrated). The I/O modules 832a-832d are associated with selected terminal modules in accordance with the disclosed embodiments of the invention with the aid of a programmable matrix module. Here, the programmable matrix module 3 is integrated in the housing 81 and, in this manner, is connected for data processing to the I/O modules 832a-832d, a processing unit and the wiring terminals 821 through the backplane bus 831. As explained in detail above, the programmable matrix module 3 can be used to freely and dynamically associate the I/O modules 832a-832d with any desired terminal modules in the wiring plane 82. As a result, it is possible to connect process signal cables to nearby terminal modules without restriction, in a manner that is favorable for connection or to also perform the connection taking into account other organizational criteria.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An automation system for controlling a technical process, comprising:
an electronic processing unit;
at least one I/O module configured to input and output process signals to operating means of the controlled technical process;
a plurality of terminal modules configured to connect the operating means to the at least one I/O module; and
a programmable matrix module operably coupled to the electronic processing unit and configured to dynamically associate the at least one I/O module with at least one of said plural terminal modules in response to the electronic processing module;
wherein the electronic processing unit is configured to associate each of said plural terminal modules with the at least one I/O module in a time-controlled manner by the programmable matrix module, and wherein one time slot is associated with each of said plural terminal modules.

2. The automation system as claimed in claim 1, wherein the matrix module includes a multiplexer.

3. The automation system as claimed in claim 1, wherein the electronic processing unit is further configured to activate the at least one I/O module through a coupling bus.

4. The automation system as claimed in claim 2, wherein the electronic processing unit is further configured to activate the at least one I/O module through a coupling bus.

5. The automation system as claimed in claim 1, wherein the electronic processing unit is further configured to detect failure of an I/O module of the at least one I/O module and to dynamically associate another I/O module of the at least one I/O module with an associated terminal module by the programmable matrix module.

6. The automation system as claimed in claim 1, wherein the electronic processing unit is further configured to monitor the at least one I/O module, determine a degree of utilization, and temporarily associate another of said plural terminal modules with the at least one I/O module.

7. The automation system as claimed in claim 1, wherein the electronic processing unit dynamically associates another one of said plural terminal modules with the at least one I/O module by the programmable matrix module if a failure of the operating means of the technical process is detected.

8. The automation system as claimed in claim 1, wherein the electronic processing unit dynamically associates a terminal module to which a redundant operating means of the technical process is connected to another I/O module of the at least one I/O module.

9. The automation system as claimed in claim 1, wherein the electronic processing unit dynamically associates each of said plural terminal modules, to which operating means of the technical process are connected, with a separate I/O module of the at least one I/O module, the operating means having states which vary slowly in comparison with a processing speed of the at least one I/O module.

10. The automation system as claimed in claim 1, wherein the electronic processing unit further comprises a search means configured to dynamically detect existing I/O modules in a first search and to dynamically detect operating means of the technical process which are connected to the terminal modules in a second search.

11. The automation system as claimed in claim 1, wherein the dynamic association performed by the electronic processing unit comprises a connection.
